(19) United States
(12) Patent Application Publication
(10) Pub. No.: US 2017/0329484 A1
(43) Pub. Date: Nov. 16, 2017

(54) Method for Zooming In/Out Picture of Handheld Electronic Device, Method for Switching Played Content of Handheld Electronic Device, and Apparatus

(71) Applicant: Huawei Technologies Co., Ltd., Shenzhen (CN)

(72) Inventors: Maosheng Huang, Shenzhen (CN); Xueyan Huang, Shenzhen (CN)

(21) Appl. No.: 15/668,131

(22) Filed: Aug. 3, 2017

Related U.S. Application Data
(63) Continuation of application No. PCT/CN2016/073077, filed on Feb. 1, 2016.

(30) Foreign Application Priority Data
Feb. 4, 2015 (CN) 201510059729.0

(51) Int. Cl. G06F 3/0485; G06F 3/0488; G06F 3/0484

(52) U.S. Cl. CPC G06F 3/0485; G06F 3/04847; G06F 3/0488

(57) ABSTRACT

A method for zooming in or out a picture of a handheld electronic device includes: obtaining a first slide touch input applied to a side touchscreen of the handheld electronic device; determining a direction of the first slide touch input; and zooming out or in, according to the direction of the first slide touch input, a picture displayed on a display screen of the handheld electronic device.

### CROSS-REFERENCE TO RELATED APPLICATIONS

This application is a continuation of International Application No. PCT/CN2016/073077, filed on Feb. 1, 2016, which claims priority to Chinese Patent Application No. 201510059729.0, filed on Feb. 4, 2015, the disclosures of the aforementioned applications are hereby incorporated by reference in their entireties.

### TECHNICAL FIELD

The present application relates to the field of electronic communications technologies, and in particular, to a method for zooming in/out a picture of a handheld electronic device, a method for switching played content of a handheld electronic device, and an apparatus.

### BACKGROUND

With development of touchscreen technologies, operating a handheld electronic device by means of a touchscreen now has become a function provided by most electronic devices, and such an operation manner also meets an operation habit of a user. Currently, most handheld electronic devices (for example, mobile phones, tablet computers, or cameras) provide a touchscreen operation function.

With development of smart mobile terminal technologies, a touchscreen has become a main display and control manner in a handheld electronic device. In most cases, a user may implement various types of control on a handheld electronic device by performing a touch operation on a display screen. A screen of a handheld electronic device is gradually expanded from initial 3.5 inches to current 5.0 inches, 5.5 inches or even larger, and it is changed gradually to meet demands of users. When a width of a display screen of a handheld electronic device exceeds a range within which a user generally can perform a touch operation with one hand, it is inconvenient for the user to perform a touch operation by operating the display screen.

### SUMMARY

Embodiments of the present application provide a method for zooming in/out a picture of a handheld electronic device, a method for switching played content of a handheld electronic device, and an apparatus, so that by touching a side touchscreen of the handheld electronic device, a user can perform a picture zooming operation on the handheld electronic device, or perform a switching operation on a picture, audio, a video, a page, or to-be-pasted content.

A first aspect provides a method for zooming in/out a picture of a handheld electronic device. The method includes obtaining a first slide touch input applied to a side touchscreen of the handheld electronic device. The method also includes determining a direction of the first slide touch input. The method also includes zooming out or in, according to the direction of the first slide touch input, a picture displayed on a display screen of the handheld electronic device.

In a first possible implementation manner of the first aspect, the determining a direction of the first slide touch input includes: determining that the direction of the first slide touch input is a first direction or a second direction; and the zooming out or in, according to the direction of the first slide touch input, a picture displayed on a display screen of the handheld electronic device includes: zooming out or in, according to the direction of the first slide touch input, the picture displayed on the display screen of the handheld electronic device, where when the direction of the first slide touch input is the first direction, zooming in the picture displayed on the display screen; or when the direction of the first slide touch input is the second direction, zooming out the picture displayed on the display screen; where a minimum angle between the second direction and the first direction is greater than or equal to 45 degrees.

With reference to the first aspect or the first possible implementation manner of the first aspect, in a second possible implementation manner, the first direction is one of an upward direction along a side, a downward direction along a side, a forward direction along a side, or a backward direction along a side; and the second direction is also one of an upward direction along a side, a downward direction along a side, a forward direction along a side, or a backward direction along a side; and the first direction is different from the second direction.

With reference to the second possible implementation manner of the first aspect, in a third possible implementation manner, after the obtaining a first slide touch input applied to a side touchscreen of the handheld electronic device; and before the zooming out or in, according to the direction of the first slide touch input, a picture displayed on a display screen of the handheld electronic device, the method further includes: determining a force of the first slide touch input.

With reference to the third possible implementation manner of the first aspect, in a fourth possible implementation manner, zooming out or in, according to the direction of the first slide touch input, a picture displayed on a display screen of the handheld electronic device, including: zooming out or in, according to the direction and the force of the first slide touch input and in a specific ratio corresponding to the force of the first slide touch input, the picture displayed on the display screen of the handheld electronic device.

With reference to the first aspect or the first possible implementation manner of the first aspect, in a fifth possible implementation manner, after the obtaining a first slide touch input applied to a side touchscreen of the handheld electronic device; and before the zooming out or in, according to the direction of the first slide touch input, a picture displayed on a display screen of the handheld electronic device, the method further includes: determining a speed of the first slide touch input.

With reference to the fifth possible implementation manner of the first aspect, in a sixth possible implementation manner, zooming out or in, according to the direction of the first slide touch input, a picture displayed on a display screen of the handheld electronic device including: zooming out or in the picture according to the direction and the speed of the first slide touch input and at a zooming speed corresponding to the speed of the first slide touch input.

With reference to any possible implementation manner of the sixth possible implementation manner of the first aspect, in a seventh possible implementation manner, the method further includes: obtaining a second slide touch input applied to the side touchscreen of the handheld electronic device; determining a direction and a speed of the second slide touch input; and zooming out or in the picture according to the direction and the speed of the second slide touch input and at a zooming speed corresponding to the speed of the second slide touch input, where the speed of the second slide touch input is greater than the speed of the first slide touch input, and the zooming speed corresponding to the speed of the second slide touch input is greater than the zooming speed corresponding to the speed of the first slide touch input.

With reference to the seventh possible implementation manner of the first aspect, in an eighth possible implementation manner, the zooming out or in the picture according to the direction and the speed of the first slide touch input and at a zooming speed corresponding to the speed of the first slide touch input includes: multiplying the speed of the first slide touch input by a to obtain the zooming speed corresponding to the speed of the first slide touch input; and the zooming out or in the picture according to the direction and the speed of the second slide touch input and at a zooming speed corresponding to the speed of the second slide touch input includes: multiplying the speed of the second slide touch input by b to obtain the zooming speed corresponding to the speed of the second slide touch input, where both a and b are constants greater than or equal to 1.

With reference to any possible implementation manner of the fifth possible implementation manner of the first aspect to the sixth possible implementation manner of the first aspect, in a ninth possible implementation manner, after the obtaining a first slide touch input applied to a side touchscreen of the handheld electronic device; and before the zooming out or in, according to the direction of the first slide touch input, a picture displayed on a display screen of the handheld electronic device, the method further includes: determining a force of the first slide touch input.

With reference to the ninth possible implementation manner of the first aspect, in a tenth possible implementation manner, wherein the zooming out or in the picture according to the direction and the speed of the first slide touch input and at a zooming speed corresponding to the speed of the first slide touch input comprises: zooming out or in, according to the direction, the speed, and the force of the first slide touch input, the picture at the zooming speed corresponding to the speed of the first slide touch input and with a zooming force corresponding to the force of the first slide touch input.

A second aspect provides a method for zooming in/out a picture of a handheld electronic device. The method includes obtaining a slide touch input applied to a side touchscreen of the handheld electronic device. The method also includes determining that a direction of the slide touch input is a first direction. The method also includes zooming in, according to the first direction, a picture displayed on a display screen of the handheld electronic device.

A third aspect provides a method for zooming in/out a picture of a handheld electronic device. The method includes obtaining a slide touch input applied to a side touchscreen of the handheld electronic device. The method also includes determining that a direction of the slide touch input is a first direction. The method also includes zooming out, according to the first direction, a picture displayed on a display screen of the handheld electronic device.

The second aspect may further include the solution for zooming in the picture displayed on the display screen of the handheld electronic device according to any possible implementation manner of the first possible implementation manner to the tenth possible implementation manner of the first aspect; and the third aspect may further include the solution for zooming out the picture displayed on the display screen of the handheld electronic device according to any possible implementation manner of the first possible implementation manner to the tenth possible implementation manner of the first aspect.

A fourth aspect provides a method for switching played content of a handheld electronic device. The method includes obtaining a first slide touch input applied to a side touchscreen of the handheld electronic device. The method also includes determining that a direction of the first slide touch input is a first direction or a second direction. The method also includes switching, when the direction of the first slide touch input is the first direction, in a document in which a currently played picture, audio, video, page, or to-be-pasted content is located, any picture, audio, video, page, or to-be-pasted content located before the currently played picture, audio, video, page, or to-be-pasted content in a play order to a new currently played picture, audio, video, page, or to-be-pasted content; or switching, when the direction of the first slide touch input is the second direction, in a document in which a currently played picture, audio, video, page, or to-be-pasted content is located, any picture, audio, video, page, or to-be-pasted content located after the currently played picture, audio, video, page, or to-be-pasted content in a play order to a new currently played picture, audio, video, page, or to-be-pasted content; where a minimum angle between the second direction and the first direction is greater than or equal to 45 degrees.

In a first possible implementation manner of the fourth aspect, the first direction is one of an upward direction along a side, a downward direction along a side, a forward direction along a side, or a backward direction along a side; and the second direction is also one of an upward direction along a side, a downward direction along a side, a forward direction along a side, or a backward direction along a side; and the first direction is different from the second direction.

With reference to any possible implementation manner of the fourth aspect to the first possible implementation manner of the fourth aspect, in a second possible implementation manner, the processor is further configured to: determining a force of the first slide touch input.

With reference to the second possible implementation manner of the fourth aspect, in a third possible implementation manner, the processor is further configured to: when the first slide touch input is in the first direction, according to the force of the first slide touch input, in the document in which the currently played picture, audio, video, page, or to-be-pasted content is located, switching the Nth (counting from the currently played picture, audio, video, page, or to-be-pasted content) picture, audio, video, page, or to-be-pasted content located before the currently played picture, audio, video, page, or to-be-pasted content in the play order to the new currently played picture, audio, video, page, or to-be-pasted content, where N is a positive integer; or when the first slide touch input is in the second direction, according to the force of the first slide touch input, in the document in which the currently played picture, audio, video, page, or to-be-pasted content is located, switching the Nth (counting from the currently played picture, audio, video, page, or to-be-pasted content) picture, audio, video, page, or to-be-pasted content located after the currently played picture, audio, video, page, or to-be-pasted content in the play order to the new currently played picture, audio, video, page, or to-be-pasted content, where N is a positive integer.

With reference to the third possible implementation manner of the fourth aspect, in a fourth possible implementation manner, the processor is further configured to: determining a speed of the first slide touch input.

With reference to the fourth possible implementation manner of the fourth aspect, in a fifth possible implementation manner, the processor is further configured to: switching, when the direction of the first slide touch input is the first direction, in the document in which the currently played picture, audio, video, page, or to-be-pasted content is located and at a switching speed corresponding to the speed of the first slide touch input, any picture, audio, video, page, or to-be-pasted content located before the currently played picture, audio, video, page, or to-be-pasted content in the play order to the new currently played picture, audio, video, page, or to-be-pasted content; or switching, when the direction of the first slide touch input is the second direction, in the document in which the currently played picture, audio, video, page, or to-be-pasted content is located and at a switching speed corresponding to the speed of the first slide touch input, any picture, audio, video, page, or to-be-pasted content located after the currently played picture, audio, video, page, or to-be-pasted content in the play order to the new currently played picture, audio, video, page, or to-be-pasted content.

With reference to the fifth possible implementation manner of the fourth aspect, in a sixth possible implementation manner, the processor is further configured to: obtaining a second slide touch input applied to the side touchscreen of the handheld electronic device; determining that a direction of the second slide touch input is the first direction or the second direction; and switching, when the direction of the second slide touch input is the first direction, in the document in which the currently played picture, audio, video, page, or to-be-pasted content is located and at a switching speed corresponding to the speed of the second slide touch input, any picture, audio, video, page, or to-be-pasted content located before the currently played picture, audio, video, page, or to-be-pasted content in the play order to the new currently played picture, audio, video, page, or to-be-pasted content; or switching, when the direction of the second slide touch input is the second direction, in the document in which the currently played picture, audio, video, page, or to-be-pasted content is located and at a switching speed corresponding to the speed of the second slide touch input, any picture, audio, video, page, or to-be-pasted content located after the currently played picture, audio, video, page, or to-be-pasted content in the play order to the new currently played picture, audio, video, page, or to-be-pasted content; where the speed of the second slide touch input is greater than the speed of the first slide touch input, and the switching speed corresponding to the speed of the second slide touch input is greater than the switching speed corresponding to the speed of the first slide touch input.

With reference to the seventh possible implementation manner of the fourth aspect, in an eighth possible implementation manner, the switching, when the direction of the second slide touch input is the first direction, in the document in which the currently played picture, audio, video, page, or to-be-pasted content is located and at a switching speed corresponding to the speed of the second slide touch input, any picture, audio, video, page, or to-be-pasted content located before the currently played picture, audio, video, page, or to-be-pasted content in the play order to the new currently played picture, audio, video, page, or to-be-pasted content includes: multiplying the speed of the first slide touch input by a to obtain the switching speed corresponding to the speed of the first slide touch input; and the switching, when the direction of the second slide touch input is the second direction, in the document in which the currently played picture, audio, video, page, or to-be-pasted content is located and at a switching speed corresponding to the speed of the second slide touch input, any picture, audio, video, page, or to-be-pasted content located after the currently played picture, audio, video, page, or to-be-pasted content in the play order to the new currently played picture, audio, video, page, or to-be-pasted content includes: multiplying the speed of the second slide touch input by b to obtain the switching speed corresponding to the speed of the second slide touch input, where both a and b are constants greater than or equal to 1.

With reference to any possible implementation manner of the fifth possible implementation manner of the fourth aspect to the sixth possible implementation manner of the fourth aspect, in a ninth possible implementation manner, the processor is further configured to: determining a force of the first slide touch input.

With reference to the ninth possible implementation manner of the fourth aspect, in a tenth possible implementation manner, when the first slide touch input is in the first direction, according to the force of the first slide touch input, in the document in which the currently played picture, audio, video, page, or to-be-pasted content is located, switching, at the switching speed corresponding to the speed of the first slide touch input, the Nth (counting from the currently played picture, audio, video, page, or to-be-pasted content) picture, audio, video, page, or to-be-pasted content located before the currently played picture, audio, video, page, or to-be-pasted content in the play order to the new currently played picture, audio, video, page, or to-be-pasted content, where N is a positive integer; or when the first slide touch input is in the second direction, according to the force of the first slide touch input, in the document in which the currently played picture, audio, video, page, or to-be-pasted content is located, switching, at the switching speed corresponding to the speed of the first slide touch input, the Nth (counting from the currently played picture, audio, video, page, or to-be-pasted content) picture, audio, video, page, or to-be-pasted content located after the currently played picture, audio, video, page, or to-be-pasted content in the play order to the new currently played picture, audio, video, page, or to-be-pasted content, where N is a positive integer.

A fifth aspect provides a handheld electronic device. The handheld electronic device includes a side sensor, configured to obtain a first slide touch input applied to a side touchscreen of the handheld electronic device. The handheld electronic device also includes a processor, configured to determine a direction of the first slide touch input. The processor is further configured to zoom out or in, according to the direction of the first slide touch input, a picture displayed on a display screen of the handheld electronic device. The handheld electronic device also includes a display screen, configured to display the picture in the handheld electronic device. The handheld electronic device also includes a memory, configured to store the picture in the handheld electronic device.

In a first possible implementation manner of the fifth aspect, the processor is further configured to determine that the direction of the slide touch input is a first direction or a second direction; when the direction of the first slide touch input is the first direction, zoom in the picture displayed on the display screen; or when the direction of the first slide touch input is the second direction, zoom out the picture displayed on the display screen; where a minimum angle between the second direction and the first direction is greater than or equal to 45 degrees.

With reference to the fifth aspect or the first possible implementation manner of the fifth aspect, in a second possible implementation manner, the first direction is one of an upward direction along a side, a downward direction along a side, a forward direction along a side, or a backward direction along a side; or the second direction is also one of an upward direction along a side, a downward direction along a side, a forward direction along a side, or a backward direction along a side; and the first direction is different from the second direction.

With reference to the second possible implementation manner of the fifth aspect, in a third possible implementation manner, the processor is further configured to determine a force of the first slide touch input.

With reference to the third possible implementation manner of the fifth aspect, in a fourth possible implementation manner, the processor is further configured to zoom out or in, according to the direction and the force of the first slide touch input and in a specific ratio corresponding to the force of the first slide touch input, the picture displayed on the display screen of the handheld electronic device.

With reference to the fifth aspect or the first possible implementation manner of the fifth aspect, in a fifth possible implementation manner, the processor is further configured to determine a speed of the first slide touch input.

With reference to the fifth possible implementation manner of the fifth aspect, in a sixth possible implementation manner, the processor is further configured to zoom out or in the picture according to the direction and the speed of the first slide touch input and at a zooming speed corresponding to the speed of the first slide touch input.

With reference to the sixth possible implementation manner of the fifth aspect, in a seventh possible implementation manner, the processor is further configured to obtain a second slide touch input applied to the side touchscreen of the handheld electronic device; determine a direction and a speed of the second slide touch input; and zoom out or in the picture according to the direction and the speed of the second slide touch input and at a second zooming speed corresponding to the speed of the second slide touch input, where the speed of the second slide touch input is greater than the speed of the first slide touch input, and the zooming speed corresponding to the speed of the second slide touch input is greater than the zooming speed corresponding to the speed of the first slide touch input.

With reference to the seventh possible implementation manner of the fifth aspect, in an eighth possible implementation manner, the processor is further configured to multiply the speed of the first slide touch input by a to obtain the zooming speed corresponding to the speed of the first slide touch input; and the processor is further configured to multiply the speed of the second slide touch input by b to obtain the zooming speed corresponding to the speed of the second slide touch input, where both a and b are constants greater than or equal to 1.

With reference to the eighth possible implementation manner of the fifth aspect, in a ninth possible implementation manner, the processor is further configured to determine a force of the first slide touch input.

With reference to the ninth possible implementation manner of the fifth aspect, in a tenth possible implementation manner, the processor is further configured to zoom out or in, according to the direction, the speed, and the force of the first slide touch input, the picture at the zooming speed corresponding to the speed of the first slide touch input and with a zooming force corresponding to the force of the first slide touch input.

A sixth aspect provides a handheld electronic device. The handheld electronic device includes a side sensor, configured to obtain a first slide touch input applied to a side touchscreen of the handheld electronic device. The handheld electronic device also includes a processor, configured to determine a direction of the first slide touch input. The processor is further configured to zoom in, according to the direction of the first slide touch input, a picture displayed on a display screen of the handheld electronic device. The handheld electronic device also includes a display screen, configured to display the picture in the handheld electronic device. The handheld electronic device also includes a memory, configured to store the picture in the handheld electronic device.

A seventh aspect provides a method for zooming in/out a picture of a handheld electronic device. The method includes a side sensor, configured to obtain a first slide touch input applied to a side touchscreen of the handheld electronic device. The handheld electronic device also includes a processor, configured to determine a direction of the first slide touch input. The processor is further configured to zoom out, according to the direction of the first slide touch input, a picture displayed on a display screen of the handheld electronic device. The handheld electronic device also includes a display screen, configured to display the picture in the handheld electronic device. The handheld electronic device also includes a memory, configured to store the picture in the handheld electronic device.

The handheld electronic device in the sixth aspect may further provide the function of zooming in the picture displayed on the display screen of the handheld electronic device according to any possible implementation manner of the first possible implementation manner to the tenth possible implementation manner of the fifth aspect; and the handheld electronic device in the seventh aspect may further provide the function of zooming out the picture displayed on the display screen of the handheld electronic device according to any possible implementation manner of the first possible implementation manner to the tenth possible implementation manner of the fifth aspect.

An eighth aspect provides a handheld electronic device, including: a side sensor, configured to obtain a first slide touch input applied to a side touchscreen of the handheld electronic device. The handheld electronic device also includes a processor, configured to determine that a direction of the first slide touch input is a first direction or a second direction. The processor is further configured to, when the direction of the first slide touch input is the first direction, in a document in which a currently played picture, audio, video, page, or to-be-pasted content is located, switch any picture, audio, video, page, or to-be-pasted content located before the currently played picture, audio, video, page, or to-be-pasted content in a play order to a new currently played picture, audio, video, page, or to-be-pasted content; or when the direction of the first slide touch input is the second direction, in a document in which a currently played picture, audio, video, page, or to-be-pasted content is located, switch any picture, audio, video, page, or to-be-pasted content located after the currently played picture, audio, video, page, or to-be-pasted content in a play order to a new currently played picture, audio, video, page, or to-be-pasted content. A minimum angle between the second direction and the first direction is greater than or equal to 45 degrees.

In a first possible implementation manner of the eighth aspect, the first direction is one of an upward direction along a side, a downward direction along a side, a forward direction along a side, or a backward direction along a side; and the second direction is also one of an upward direction along a side, a downward direction along a side, a forward direction along a side, or a backward direction along a side; and the first direction is different from the second direction.

With reference to the eighth aspect or the first possible implementation manner of the eighth aspect, in a second possible implementation manner, the processor is further configured to determine a force of the first slide touch input.

With reference to the second possible implementation manner of the eighth aspect, in a third possible implementation manner, the processor is further configured to: when according to the force of the first slide touch input, in the document in which the currently played picture, audio, video, page, or to-be-pasted content is located, switch the Nth picture, audio, video, page, or to-be-pasted content located before the currently played picture, audio, video, page, or to-be-pasted content in the play order to the new currently played picture, audio, video, page, or to-be-pasted content, where N is a positive integer; and the processor is further configured to: when the first slide touch input is in a direction opposite to a specific direction, according to the force of the first slide touch input, in the document in which the currently played picture, audio, video, page, or to-be-pasted content is located, switch the Nth picture, audio, video, page, or to-be-pasted content located after the currently played picture, audio, video, page, or to-be-pasted content in the play order to the new currently played picture, audio, video, page, or to-be-pasted content, where N is a positive integer.

With reference to the eighth aspect or the first possible implementation manner of the eighth aspect, in a fourth possible implementation manner, the processor is further configured to determine a speed of the first slide touch input.

With reference to the fourth possible implementation manner of the eighth aspect, in a fifth possible implementation manner, the processor is further configured to: when the direction of the first slide touch input is the first direction, in the document in which the currently played picture, audio, video, page, or to-be-pasted content is located, switch, at a switching speed corresponding to the speed of the first slide touch input, any picture, audio, video, page, or to-be-pasted content located before the currently played picture, audio, video, page, or to-be-pasted content in the play order to the new currently played picture, audio, video, page, or to-be-pasted content; or when the direction of the first slide touch input is the second direction, in the document in which the currently played picture, audio, video, page, or to-be-pasted content is located, switch, at a switching speed corresponding to the speed of the first slide touch input, any picture, audio, video, page, or to-be-pasted content located after the currently played picture, audio, video, page, or to-be-pasted content in the play order to the new currently played picture, audio, video, page, or to-be-pasted content.

With reference to the fifth possible implementation manner of the eighth aspect, in a sixth possible implementation manner, the processor is further configured to obtain a second slide touch input applied to the side touchscreen of the handheld electronic device; determine that a direction of the second slide touch input is the first direction or the second direction; and when the direction of the second slide touch input is the first direction, in the document in which the currently played picture, audio, video, page, or to-be-pasted content is located, switch, at a switching speed corresponding to the speed of the second slide touch input, any picture, audio, video, page, or to-be-pasted content located before the currently played picture, audio, video, page, or to-be-pasted content in the play order to the new currently played picture, audio, video, page, or to-be-pasted content; or when the direction of the second slide touch input is the second direction, in the document in which the currently played picture, audio, video, page, or to-be-pasted content is located, switch, at a switching speed corresponding to the speed of the second slide touch input, any picture, audio, video, page, or to-be-pasted content located after the currently played picture, audio, video, page, or to-be-pasted content in the play order to the new currently played picture, audio, video, page, or to-be-pasted content; where the speed of the second slide touch input is greater than the speed of the first slide touch input, and the switching speed corresponding to the speed of the second slide touch input is greater than the switching speed corresponding to the speed of the first slide touch input.

With reference to the sixth possible implementation manner of the eighth aspect, in a seventh possible implementation manner, the processor is further configured to multiply the speed of the first slide touch input by a to obtain the switching speed corresponding to the speed of the first slide touch input; and multiply the speed of the second slide touch input by b to obtain the switching speed corresponding to the speed of the second slide touch input, where both a and b are constants greater than or equal to 1.

With reference to any possible implementation manner of the fifth possible implementation manner of the eighth aspect to the seventh possible implementation manner of the eighth aspect, in an eighth possible implementation manner, the processor is further configured to determine a force of the first slide touch input.

With reference to the eighth possible implementation manner of the eighth aspect, in a ninth possible implementation manner, the processor is further configured to: when the first slide touch input is in the first direction, according to the force of the first slide touch input, in the document in which the currently played picture, audio, video, page, or to-be-pasted content is located, switch, at the switching speed corresponding to the speed of the first slide touch input, the Nth (counting from the currently played picture, audio, video, page, or to-be-pasted content) picture, audio, video, page, or to-be-pasted content located before the currently played picture, audio, video, page, or to-be-pasted content in the play order to the new currently played picture, audio, video, page, or to-be-pasted content, where N is a positive integer; or when the first slide touch input is in the second direction, according to the force of the first slide touch input, in the document in which the currently played picture, audio, video, page, or to-be-pasted content is located, switch, at the switching speed corresponding to the speed of the first slide touch input, the Nth (counting from the currently played picture, audio, video, page, or to-be-pasted content) picture, audio, video, page, or to-be-pasted content located after the currently played picture, audio, video, page, or to-be-pasted content in the play order to the new currently played picture, audio, video, page, or to-be-pasted content, where N is a positive integer.

### BRIEF DESCRIPTION OF THE DRAWINGS

To describe the technical solutions in the embodiments of the present application more clearly, the following briefly describes the accompanying drawings required for describing the embodiments. Apparently, the accompanying drawings in the following description show some embodiments of the present application, and persons of ordinary skill in the art may still derive other drawings from these accompanying drawings without creative efforts.

FIG. 1a is a schematic diagram of an external structure of a handheld electronic device according to an embodiment of the present application;

FIG. 1b is a schematic operational diagram of a handheld electronic device according to an embodiment of the present application;

FIG. 2 is a diagram of an internal implementation principle of a handheld electronic device according to an embodiment of the present application;

FIG. 3 is a flowchart of a method for zooming in/out a picture of a handheld electronic device according to an embodiment of the present application;

FIG. 4 is a flowchart of a method for switching a picture, audio, a video, a page, or to-be-pasted content of a handheld electronic device according to an embodiment of the present application; and

FIG. 5 is a diagram of an implementation principle of a handheld electronic device zooming in/out a picture by using a side sensor according to an embodiment of the present application; and FIG. 5 is also a diagram of an implementation principle of a handheld electronic device switching a picture, audio, a video, a page, or to-be-pasted content by using a side sensor according to an embodiment of the present application.

### DETAILED DESCRIPTION OF ILLUSTRATIVE EMBODIMENTS

To make the objectives, technical solutions, and advantages of the embodiments of the present application clearer, the following clearly describes the technical solutions in the embodiments of the present application with reference to the accompanying drawings in the embodiments of the present application. Apparently, the described embodiments are some but not all of the embodiments of the present application. All other embodiments obtained by persons of ordinary skill in the art based on the embodiments of the present application without creative efforts shall fall within the protection scope of the present application.

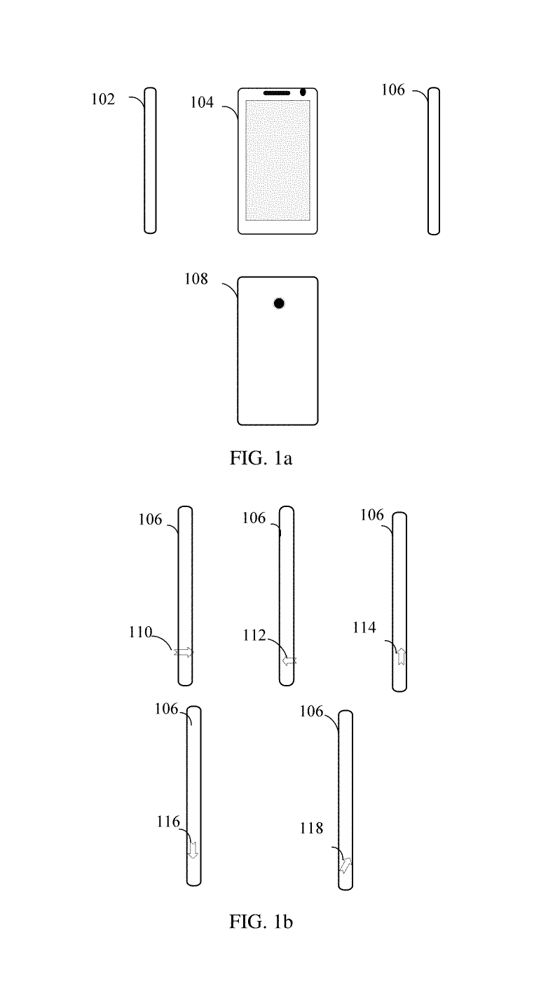

As shown in FIG. 1a, FIG. 1a is a schematic diagram of an external structure of a handheld electronic device according to an embodiment of the present application.

As shown in the figure, the handheld electronic device provided in the present application includes a left side 102, a front surface 104, a right side 106, and a rear surface 108.

A slide touch sensor is disposed on the left side 102 or the right side 104 of the handheld electronic device, or a slide touch sensor is disposed on both the left side 102 and the right side 104, to detect a slide touch of a user on a side of the handheld electronic device.

The handheld electronic device includes: a handheld assistant, a mobile phone, a tablet computer, a camera, an MP3, an MP4, an MP5, a palmtop computer, a handheld game console, a smart band, a smart watch, a vertical application device (VAD) and the like.

As shown in FIG. 1b, FIG. 1b is a schematic operational diagram of a handheld electronic device according to an embodiment of the present application.

A slide touch sensor of the handheld electronic device provides a direction detection function, used to detect a direction of a user slide touch; or may provide a force detection function or a speed detection function, used to control and execute a force or speed operation based on the direction; or may provide the three functions, used to detect a direction, a force, and a speed of a user slide touch.

The direction is a slide direction of a slide touch operation of a user, the figure shows a slide touch input on a side touchscreen at the right side 106, and the side touchscreen is located on a side. The slide touch may be an upward slide 114, a downward slide 116, a forward left slide 112, a backward slide no, or a slide in another specific angle, such as 118. The upward slide is a slide along the left side or right side of the handheld electronic device and in a direction towards an upper side of the handheld electronic device; the downward slide is opposite to the direction of the upward slide; the forward slide is a slide in a direction towards the front surface of the handheld electronic device; and the backward slide is opposite to the direction of the forward slide, and is a slide in a direction towards the rear surface of the handheld electronic device. When the slide touch input is in a first direction, a picture is zoomed in; and when the slide touch input is in a second direction, the picture is zoomed out. In another case, when the slide touch input is in the first direction, an element before a currently played picture, audio, video, page, or to-be-pasted content is switched to a currently played element; and when the slide touch input is in the second direction, an element after the currently played picture, audio, video, page, or to-be-pasted content is switched to a currently played element. A force of the slide touch input decides a zooming ratio of the picture.

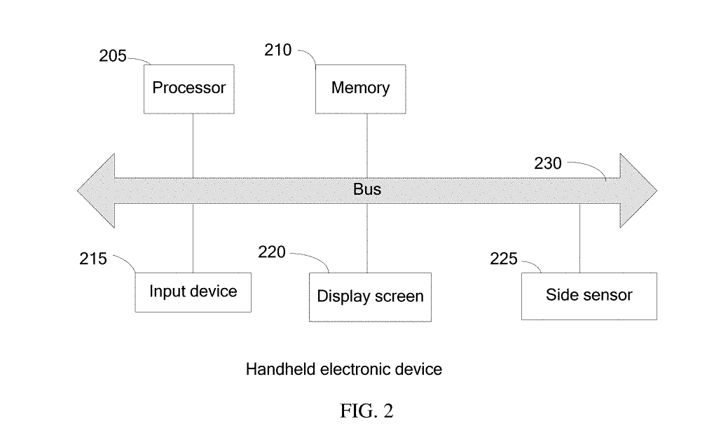

As shown in FIG. 2, FIG. 2 is a diagram of an internal implementation principle of a handheld electronic device according to an embodiment of the present application.

The handheld electronic device includes a processor 205, a memory 210, an input device 215, a display screen 220, and a side sensor 225. The components are connected by means of a bus 230. The device further includes a side touchscreen, and the side touchscreen is disposed on an outer surface of the side sensor. The device runs by combining software and hardware.

In one aspect, compared with a picture zooming operation method, specifically, the side sensor 225 is configured to obtain a slide touch input applied to the side touchscreen of the handheld electronic device; specifically, the slide touch input is used to instruct to zoom in or out the picture; the slide touch input is obtained by the side sensor 225; and a side of the handheld electronic device is specifically the left side 102 or the right side 106 of the handheld electronic device in FIG. 1a or FIG. 1b. The processor 205 is configured to determine a direction of the slide touch input; and specifically, the processor 205 obtains the direction of the slide touch input according to the slide touch input sent by the side sensor 225. The direction is a slide direction of a slide touch operation of a user, and may be an upward slide, a downward slide, a leftward slide, a rightward slide, a forward slide, a backward slide, or a slide in a specific angle. As shown in FIG. 1b, an slide touch input no applied to the right side 106 is a forward slide; the processor 205 is further configured to zoom out or in, according to the direction of the slide touch input, a picture displayed on the display screen 220 of the handheld electronic device, and specifically, the processor 205 invokes a mapping relationship stored in the memory 210, and sends, according to the mapping relationship, an instruction that is for zooming in or out the picture and that corresponds to a force of the slide touch input, to zoom the picture.

Further, the processor 205 is further configured to: when determining that the direction of the slide touch input is a specific direction, zoom in the picture displayed on the display screen 220; and further, the processor 205 is further configured to: when determining that the direction of the slide touch input is a direction opposite to the specific direction, zoom out the picture displayed on the display screen 220. Further, the processor 205 is further configured to determine the force of the slide touch input. Further, the processor 205 is further configured to zoom out or in, according to the direction and the force of the slide touch input and in a specific ratio corresponding to the force of the slide touch input, the picture displayed on the display screen 220 of the handheld electronic device. Further, the processor 205 is further configured to determine a speed of the slide touch input; further, the processor 205 is further configured to zoom out or in the picture according to the direction and the speed of the slide touch input and at a zooming speed corresponding to the speed of the slide touch input, where the zooming speed is in direct proportion to the speed of the slide touch input. Specifically, the processor accesses, according to the speed of the slide touch input, a mapping relationship, stored in the memory, between the slide touch input and the zooming of the picture. A smaller speed indicates a lower speed at which the picture is zoomed out or in; on the contrary, a greater speed indicates a faster speed at which the picture is zoomed out or in. The slide touch speed is approximate to a touch speed at which a user touches a touchscreen of a mobile device in the prior art. Further, the processor 205 is further configured to determine the force of the slide touch input. Further, the processor 205 is further configured to zoom out or in the picture according to the direction, the speed, and the force of the slide touch input, and at a zooming speed and a zooming force that correspond to the direction, the speed, and the force of the slide touch input.

In another aspect, in terms of an operation of switching a picture, audio, a video, a page, or to-be-pasted content, similar to the picture zooming operation method in the foregoing one aspect, specifically, the side sensor 225 is configured to obtain a slide touch input applied to a side touchscreen of the handheld electronic device; the processor 205 is configured to determine a direction of the slide touch input; and the processor 205 is further configured to switch, according to the direction of the slide touch input, a currently played picture, audio, video, page, or to-be-pasted content on the display screen 220 of the handheld electronic device.

Further, the processor is further configured to: when the slide touch input is in a specific direction, in a document in which the currently played picture, audio, video, page, or to-be-pasted content is located, switch any picture, audio, video, page, or to-be-pasted content stored before the currently played picture, or audio, or video, or page to a new currently played picture, audio, video, page, or to-be-pasted content.

The processor is further configured to: when the slide touch input is in a direction opposite to the specific direction, in the document in which the currently played picture, audio, video, page, or to-be-pasted content is located, switch any picture, audio, video, page, or to-be-pasted content stored after the currently played picture, or audio, or video, or page to a new currently played picture, audio, video, page, or to-be-pasted content. Further, the processor is further configured to determine a force of the slide touch input. Further, the processor is further configured to: when according to the force of the slide touch input, in the document in which the currently played picture, audio, video, page, or to-be-pasted content is located, switch the Nth picture, audio, video, page, or to-be-pasted content stored before the currently played picture, audio, video, page, or to-be-pasted content to the new currently played picture, audio, video, page, or to-be-pasted content, where N is a positive integer; and the processor is further configured to: when the slide touch input is in a direction opposite to the specific direction, according to the force of the slide touch input, in the document in which the currently played picture, audio, video, page, or to-be-pasted content is located, switch the Nth picture, audio, video, page, or to-be-pasted content stored before the currently played picture, audio, video, page, or to-be-pasted content to the new currently played picture, audio, video, page, or to-be-pasted content, where N is a positive integer. Further, the processor is further configured to determine a speed of the slide touch input. Further, the processor is further configured to switch, according to the direction and the speed of the slide touch input and at a switching speed corresponding to the speed of the slide touch input, the picture, audio, video, page, or to-be-pasted content that is currently played on the display screen of the handheld electronic device. Further, the processor is further configured to determine the force of the slide touch input. Further, the processor is further configured to: when the slide touch input is in a specific direction, according to the force of the slide touch input, in the document in which the currently played picture, audio, video, page, or to-be-pasted content is located, switch, at the switching speed corresponding to the speed of the slide touch input, the Nth picture, audio, video, page, or to-be-pasted content stored before the currently played picture, audio, video, page, or to-be-pasted content to the new currently played picture, audio, video, page, or to-be-pasted content, where a value of N is in direct proportion to the force of the slide touch input, and N is a positive integer; and the processor is further configured to: when the slide touch input is in a direction opposite to the specific direction, according to the force of the slide touch input, in the document in which the currently played picture, audio, video, page, or to-be-pasted content is located, switch, at the switching speed corresponding to the speed of the slide touch input, the Nth picture, audio, video, page, or to-be-pasted content stored after the currently played picture, audio, video, page, or to-be-pasted content to the new currently played picture, audio, video, page, or to-be-pasted content, where a value of N is in direct proportion to the force of the slide touch input, and N is a positive integer.

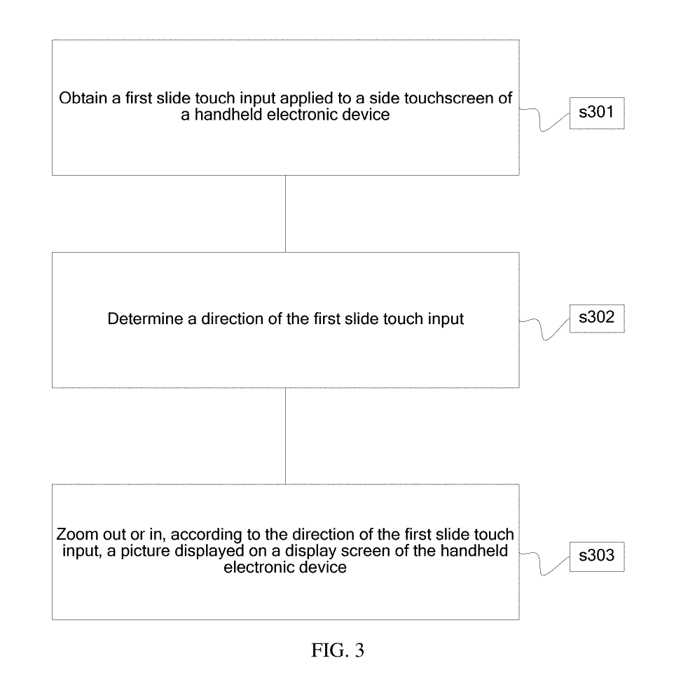

FIG. 3 is a flowchart of a method for zooming in/out a picture of a handheld electronic device according to an embodiment of the present application.

For a specific implementation process of the handheld electronic device according to the content of this embodiment, refer to the picture zooming operation method described in the foregoing one aspect in FIG. 2. This embodiment includes the following steps.

Step S301: Obtain a first slide touch input applied to a side touchscreen of the handheld electronic device; determine a direction of the first slide touch input; and zoom out or in, according to the direction of the first slide touch input, a picture displayed on a display screen of the handheld electronic device.

Step S302: The determining a direction of the first slide touch input includes: determining that the direction of the first slide touch input is a first direction or a second direction; and the zooming out or in, according to the direction of the first slide touch input, a picture displayed on a display screen of the handheld electronic device includes: zooming out or in, according to the direction of the first slide touch input, the picture displayed on the display screen of the handheld electronic device, where when the direction of the first slide touch input is the first direction, zooming in the picture displayed on the display screen; or when the direction of the first slide touch input is the second direction, zooming out the picture displayed on the display screen; where a minimum angle between the second direction and the first direction is greater than or equal to 45 degrees.

Further, step S303: The first direction is one of an upward direction along a side, a downward direction along a side, a forward direction along a side, or a backward direction along a side; and the second direction is also one of an upward direction along a side, a downward direction along a side, a forward direction along a side, or a backward direction along a side; and the first direction is different from the second direction.

Further, step S304: After the obtaining a first slide touch input applied to a side touchscreen of the handheld electronic device, and before the zooming out or in, according to the direction of the first slide touch input, a picture displayed on a display screen of the handheld electronic device, the method further includes: determining a force of the first slide touch input.

Further, step S305: The zooming out or in, according to the direction of the first slide touch input, a picture displayed on a display screen of the handheld electronic device includes: zooming out or in, according to the direction and the force of the first slide touch input and in a specific ratio corresponding to the force of the first slide touch input, the picture displayed on the display screen of the handheld electronic device.

Further, step S306: After the obtaining a first slide touch input applied to a side touchscreen of the handheld electronic device, and before the zooming out or in, according to the direction of the first slide touch input, a picture displayed on a display screen of the handheld electronic device, the method further includes: determining a speed of the first slide touch input.

Further, step S307: The zooming out or in, according to the direction of the first slide touch input, a picture displayed on a display screen of the handheld electronic device includes: zooming out or in the picture according to the direction and the speed of the first slide touch input and at a zooming speed corresponding to the speed of the first slide touch input. Further, step S308: Obtain a second slide touch input applied to the side touchscreen of the handheld electronic device; determine a direction and a speed of the second slide touch input; and zoom out or in the picture according to the direction and the speed of the second slide touch input and at a zooming speed corresponding to the speed of the second slide touch input, where the speed of the second slide touch input is greater than the speed of the first slide touch input, and the zooming speed corresponding to the speed of the second slide touch input is greater than the zooming speed corresponding to the speed of the first slide touch input.

Further, step S309: The zooming out or in the picture according to the direction and the speed of the first slide touch input and at a zooming speed corresponding to the speed of the first slide touch input includes: multiplying the speed of the first slide touch input by a to obtain the zooming speed corresponding to the speed of the first slide touch input, where a is a constant greater than or equal to 1; and zooming out or in the picture at the zooming speed corresponding to the speed of the first slide touch input.

Further, step S310: After the obtaining a first slide touch input applied to a side touchscreen of the handheld electronic device; and before the zooming out or in, according to the direction of the first slide touch input, a picture displayed on a display screen of the handheld electronic device, the method further includes: determining a force of the first slide touch input.

Further, step S311: The zooming out or in the picture according to the direction and the speed of the first slide touch input, and at a zooming speed corresponding to the speed of the first slide touch input includes: zooming out or in, according to the direction, the speed, and the force of the first slide touch input, the picture at the zooming speed corresponding to the speed of the first slide touch input and with a zooming force corresponding to the force of the first slide touch input.

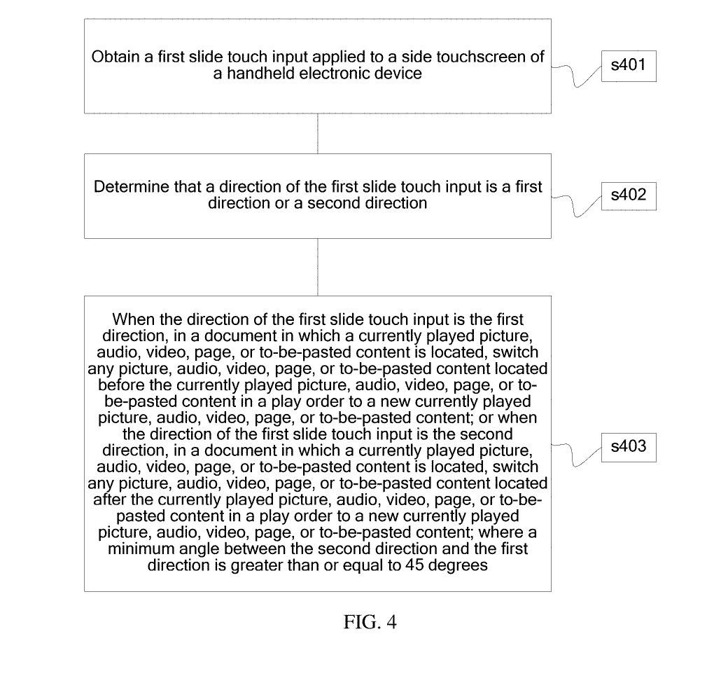

FIG. 4 is a flowchart of a method for switching a picture, audio, a video, a page, or to-be-pasted content of a handheld electronic device according to an embodiment of the present application.

For a specific implementation process of the handheld electronic device according to the content of this embodiment, refer to the method for switching a picture, audio, a video, a page, or to-be-pasted content described in the foregoing another aspect in FIG. 2. This embodiment includes the following steps.

Step 401: Obtain a first slide touch input applied to a side touchscreen of the handheld electronic device; determine that a direction of the first slide touch input is a first direction or a second direction; and switch, when the direction of the first slide touch input is the first direction, in a document in which a currently played picture, audio, video, page, or to-be-pasted content is located, any picture, audio, video, page, or to-be-pasted content located before the currently played picture, audio, video, page, or to-be-pasted content in a play order to a new currently played picture, audio, video, page, or to-be-pasted content; or switch, when the direction of the first slide touch input is the second direction, in a document in which a currently played picture, audio, video, page, or to-be-pasted content is located, any picture, audio, video, page, or to-be-pasted content located after the currently played picture, audio, video, page, or to-be-pasted content in a play order to a new currently played picture, audio, video, page, or to-be-pasted content; where a minimum angle between the second direction and the first direction is greater than or equal to 45 degrees.

Step S402: The first direction is one of an upward direction along a side, a downward direction along a side, a forward direction along a side, or a backward direction along a side; and the second direction is also one of an upward direction along a side, a downward direction along a side, a forward direction along a side, or a backward direction along a side; and the first direction is different from the second direction.

Further, step S403: After the obtaining a first slide touch input applied to a side touchscreen of the handheld electronic device, and before the switching, when the direction of the first slide touch input is the first direction, in a document in which a currently played picture, audio, video, page, or to-be-pasted content is located, any picture, audio, video, page, or to-be-pasted content located before the currently played picture, audio, video, page, or to-be-pasted content in a play order to a new currently played picture, audio, video, page, or to-be-pasted content, the method further includes: determining a force of the first slide touch input.

Further, step S404: The switching, when the direction of the first slide touch input is the first direction, in a document in which a currently played picture, audio, video, page, or to-be-pasted content is located, any picture, audio, video, page, or to-be-pasted content located before the currently played picture, audio, video, page, or to-be-pasted content in a play order to a new currently played picture, audio, video, page, or to-be-pasted content; or the switching, when the direction of the first slide touch input is the second direction, in a document in which a currently played picture, audio, video, page, or to-be-pasted content is located, any picture, audio, video, page, or to-be-pasted content located after the currently played picture, audio, video, page, or to-be-pasted content in a play order to a new currently played picture, audio, video, page, or to-be-pasted content includes: when the first slide touch input is in the first direction, according to the force of the first slide touch input, in the document in which the currently played picture, audio, video, page, or to-be-pasted content is located, switching the Nth (counting from the currently played picture, audio, video, page, or to-be-pasted content) picture, audio, video, page, or to-be-pasted content located before the currently played picture, audio, video, page, or to-be-pasted content in the play order to the new currently played picture, audio, video, page, or to-be-pasted content, where N is a positive integer; or when the first slide touch input is in the second direction, according to the force of the first slide touch input, in the document in which the currently played picture, audio, video, page, or to-be-pasted content is located, switching the Nth (counting from the currently played picture, audio, video, page, or to-be-pasted content) picture, audio, video, page, or to-be-pasted content located after the currently played picture, audio, video, page, or to-be-pasted content in the play order to the new currently played picture, audio, video, page, or to-be-pasted content, where N is a positive integer.

Further, step S405: After the obtaining a first slide touch input applied to a side touchscreen of the handheld electronic device, and before the switching, when the direction of the first slide touch input is the first direction, in a document in which a currently played picture, audio, video, page, or to-be-pasted content is located, any picture, audio, video, page, or to-be-pasted content located before the currently played picture, audio, video, page, or to-be-pasted content in a play order to a new currently played picture, audio, video, page, or to-be-pasted content, the method further includes: determining a speed of the first slide touch input.

Further, step S406: The switching, when the direction of the first slide touch input is the first direction, in a document in which a currently played picture, audio, video, page, or to-be-pasted content is located, any picture, audio, video, page, or to-be-pasted content located before the currently played picture, audio, video, page, or to-be-pasted content in a play order to a new currently played picture, audio, video, page, or to-be-pasted content; or the switching, when the direction of the first slide touch input is the second direction, in a document in which a currently played picture, audio, video, page, or to-be-pasted content is located, any picture, audio, video, page, or to-be-pasted content located after the currently played picture, audio, video, page, or to-be-pasted content in a play order to a new currently played picture, audio, video, page, or to-be-pasted content includes: switching, when the direction of the first slide touch input is the first direction, in the document in which the currently played picture, audio, video, page, or to-be-pasted content is located and at a switching speed corresponding to the speed of the first slide touch input, any picture, audio, video, page, or to-be-pasted content located before the currently played picture, audio, video, page, or to-be-pasted content in the play order to the new currently played picture, audio, video, page, or to-be-pasted content; or switching, when the direction of the first slide touch input is the second direction, in the document in which the currently played picture, audio, video, page, or to-be-pasted content is located and at a switching speed corresponding to the speed of the first slide touch input, any picture, audio, video, page, or to-be-pasted content located after the currently played picture, audio, video, page, or to-be-pasted content in the play order to the new currently played picture, audio, video, page, or to-be-pasted content.

Further, step S407: Obtain a second slide touch input applied to the side touchscreen of the handheld electronic device; determine that a direction of the second slide touch input is the first direction or the second direction; switch, when the direction of the second slide touch input is the first direction, in the document in which the currently played picture, audio, video, page, or to-be-pasted content is located and at a switching speed corresponding to the speed of the second slide touch input, any picture, audio, video, page, or to-be-pasted content located before the currently played picture, audio, video, page, or to-be-pasted content in the play order to the new currently played picture, audio, video, page, or to-be-pasted content; or switch, when the direction of the second slide touch input is the second direction, in the document in which the currently played picture, audio, video, page, or to-be-pasted content is located and at a switching speed corresponding to the speed of the second slide touch input, any picture, audio, video, page, or to-be-pasted content located after the currently played picture, audio, video, page, or to-be-pasted content in the play order to the new currently played picture, audio, video, page, or to-be-pasted content; where the speed of the second slide touch input is greater than the speed of the first slide touch input, and the switching speed corresponding to the speed of the second slide touch input is greater than the switching speed corresponding to the speed of the first slide touch input.

Further, step S408: The switching, when the direction of the second slide touch input is the first direction, in the document in which the currently played picture, audio, video, page, or to-be-pasted content is located and at a switching speed corresponding to the speed of the second slide touch input, any picture, audio, video, page, or to-be-pasted content located before the currently played picture, audio, video, page, or to-be-pasted content in the play order to the new currently played picture, audio, video, page, or to-be-pasted content includes: multiplying the speed of the first slide touch input by a to obtain the switching speed corresponding to the speed of the first slide touch input, and when the direction of the second slide touch input is the first direction, in the document in which the currently played picture, audio, video, page, or to-be-pasted content is located, switching, at the switching speed corresponding to the speed of the second slide touch input, any picture, audio, video, page, or to-be-pasted content located before the currently played picture, audio, video, page, or to-be-pasted content in the play order to the new currently played picture, audio, video, page, or to-be-pasted content; and the switching, when the direction of the second slide touch input is the second direction, in the document in which the currently played picture, audio, video, page, or to-be-pasted content is located and at a switching speed corresponding to the speed of the second slide touch input, any picture, audio, video, page, or to-be-pasted content located after the currently played picture, audio, video, page, or to-be-pasted content in the play order to the new currently played picture, audio, video, page, or to-be-pasted content includes: multiplying the speed of the second slide touch input by b to obtain the switching speed corresponding to the speed of the second slide touch input, and when the direction of the second slide touch input is the second direction, in the document in which the currently played picture, audio, video, page, or to-be-pasted content is located, switching, at the switching speed corresponding to the speed of the second slide touch input, any picture, audio, video, page, or to-be-pasted content located after the currently played picture, audio, video, page, or to-be-pasted content in the play order to the new currently played picture, audio, video, page, or to-be-pasted content.

Both a and b are constants greater than or equal to 1. Further, step S409: After the obtaining a first slide touch input applied to a side touchscreen of the handheld electronic device, and before the switching, when the direction of the first slide touch input is the first direction, in the document in which the currently played picture, audio, video, page, or to-be-pasted content is located and at a switching speed corresponding to the speed of the first slide touch input, any picture, audio, video, page, or to-be-pasted content located before the currently played picture, audio, video, page, or to-be-pasted content in the play order to the new currently played picture, audio, video, page, or to-be-pasted content, the method further includes: determining a force of the first slide touch input.

Further, step S410: The switching, when the direction of the first slide touch input is the first direction, in a document in which a currently played picture, audio, video, page, or to-be-pasted content is located, any picture, audio, video, page, or to-be-pasted content located before the currently played picture, audio, video, page, or to-be-pasted content in a play order to a new currently played picture, audio, video, page, or to-be-pasted content; or the switching, when the direction of the first slide touch input is the second direction, in a document in which a currently played picture, audio, video, page, or to-be-pasted content is located, any picture, audio, video, page, or to-be-pasted content located after the currently played picture, audio, video, page, or to-be-pasted content in a play order to a new currently played picture, audio, video, page, or to-be-pasted content includes: when the first slide touch input is in the first direction, according to the force of the first slide touch input, in the document in which the currently played picture, audio, video, page, or to-be-pasted content is located, switching, at the switching speed corresponding to the speed of the first slide touch input, the Nth (counting from the currently played picture, audio, video, page, or to-be-pasted content) picture, audio, video, page, or to-be-pasted content located before the currently played picture, audio, video, page, or to-be-pasted content in the play order to the new currently played picture, audio, video, page, or to-be-pasted content, where N is a positive integer; or when the first slide touch input is in the second direction, according to the force of the first slide touch input, in the document in which the currently played picture, audio, video, page, or to-be-pasted content is located, switching, at the switching speed corresponding to the speed of the first slide touch input, the Nth (counting from the currently played picture, audio, video, page, or to-be-pasted content) picture, audio, video, page, or to-be-pasted content located after the currently played picture, audio, video, page, or to-be-pasted content in the play order to the new currently played picture, audio, video, page, or to-be-pasted content, where N is a positive integer.

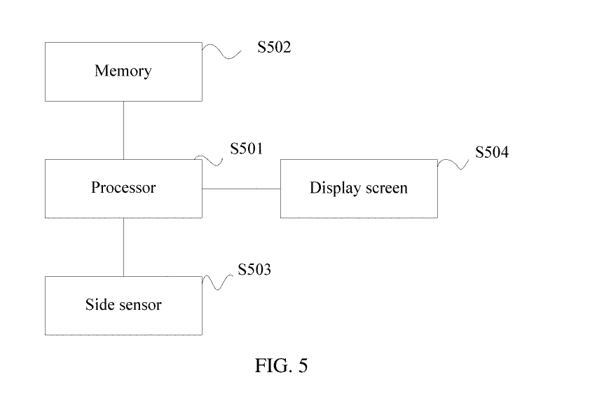

FIG. 5 is a diagram of an implementation principle of a handheld electronic device zooming in/out a picture by using a side sensor according to an embodiment of the present application.

For a specific implementation process of this embodiment, refer to the content of the foregoing one aspect described in FIG. 2. A correspondence between specific components is: the function of the processor 205 in FIG. 2 is implemented by a processor 501, the function of the memory 210 is implemented by a memory 502, the function of the display screen 220 is implemented by a display 504, and the function of the side sensor 225 is implemented by a side sensor 503. A specific implementation step of this embodiment may also correspond to the method of FIG. 3.

FIG. 5 is also a diagram of an implementation principle of a handheld electronic device switching a picture, audio, a video, a page, or to-be-pasted content by using a side sensor according to an embodiment of the present application.

For a specific implementation process of this embodiment, refer to the content of the foregoing another aspect described in FIG. 2. A correspondence between specific components is as described above. Specific implementation steps of this embodiment may also correspond to the method of FIG. 4. The present application may be implemented in multiple implementation manners. The embodiments of the present application may be performed by particular software/hardware components. Persons skilled in the art consider that various different software or hardware combinations may also be applied to perform the embodiments of the present application. The foregoing particular operations performed by hardware may also be implemented by software.

Multiple characteristics of the present application that are included in a computer program may be coded and stored in multiple computer readable storage media. A suitable medium includes a magnetic disk or a magnetic tape, or an optical storage medium such as a hard disk or a flash memory, or other non-transient storage media or cloud.

Finally, it should be noted that the foregoing embodiments are merely intended for describing the technical solutions of the present application, but not for limiting the present application. Although the present application is described in detail with reference to the foregoing embodiments, persons of ordinary skill in the art should understand that they may still make modifications to the technical solutions described in the foregoing embodiments or make equivalent replacements to some or all technical features thereof, without departing from the scope of the technical solutions of the embodiments of the present application.

What is claimed is:

1. A method, comprising:
obtaining a first slide touch input applied to a side touchscreen of a handheld electronic device;
determining a direction of the first slide touch input; and
zooming out of, or into, a picture according to the direction of the first slide touch input, wherein the picture is displayed on a display screen of the handheld electronic device.

2. The method according to claim 1, wherein determining the direction of the first slide touch input comprises:
determining that the direction of the first slide touch input is a first direction or a second direction; and
wherein zooming out of, or into, the picture comprises:
zooming into the picture displayed on the display screen when the direction of the first slide touch input is the first direction; and
zooming out of the picture displayed on the display screen when the direction of the first slide touch input is the second direction; and
wherein a minimum angle between the second direction and the first direction is greater than or equal to 45 degrees.

3. The method according to claim 1, wherein the first direction is one of a forward direction along a side or a backward direction along a side; and
wherein the second direction is also one of a forward direction along a side or a backward direction along a side, and wherein the first direction is different from the second direction.

4. The method according to claim 3, wherein the method further comprises:
determining a force of the first slide touch input after the obtaining the first slide touch input and before the zooming out of, or into, the picture.

5. The method according to claim 4, wherein the zooming out of, or into, the picture, comprises:
zooming out or in, according to the direction and the force of the first slide touch input and in a specific ratio corresponding to the force of the first slide touch input, the picture displayed on the display screen of the handheld electronic device.

6. The method according to claim 1, wherein the method further comprises:
determining a speed of the first slide touch input after the obtaining the first slide touch input and before the zooming out of, or into, the picture.

7. The method according to claim 6, wherein the zooming out of, or into, the picture, comprises:
zooming out of, or into, the picture according to the direction and the speed of the first slide touch input and at a zooming speed corresponding to the speed of the first slide touch input.

8. The method according to claim 7, wherein the method further comprises:
obtaining a second slide touch input applied to the side touchscreen of the handheld electronic device;
determining a direction and a speed of the second slide touch input; and
zooming out or in the picture according to the direction and the speed of the second slide touch input and at a zooming speed corresponding to the speed of the second slide touch input, wherein the speed of the second slide touch input is greater than the speed of the first slide touch input, and wherein the zooming speed corresponding to the speed of the second slide touch input is greater than the zooming speed corresponding to the speed of the first slide touch input.

9. The method according to claim 8, wherein the according to the direction and the speed of the first slide touch input and at the zooming speed corresponding to the speed of the first slide touch input comprises:
multiplying the speed of the first slide touch input by a first value to obtain the zooming speed corresponding to the speed of the first slide touch input, wherein the first value is a constant greater than or equal to 1; and
zooming out of, or into, the picture at the zooming speed corresponding to the speed of the first slide touch input.

10. The method according to claim 9, wherein the method further comprises:
determining a force of the first slide touch input after the obtaining the first slide touch input applied and before the zooming out of, or into, the picture.

11. The method according to claim 10, wherein the zooming out of, or into, the picture according to the direction and the speed of the first slide touch input and at the zooming speed corresponding to the speed of the first slide touch input comprises:
zooming out or in, according to the direction, the speed, and the force of the first slide touch input, the picture at the zooming speed corresponding to the speed of the first slide touch input and with a zooming force corresponding to the force of the first slide touch input.

12. A method for switching played content of a handheld electronic device, comprising:
obtaining a first slide touch input applied to a side touchscreen of the handheld electronic device;
determining that a direction of the first slide touch input is a first direction or a second direction; and
performing one of:
switching, when the direction of the first slide touch input is the first direction, in a document in which a currently played picture, audio, video, page, or to-be-pasted content is located, a picture, audio, video, page, or to-be-pasted content located before the currently played picture, audio, video, page, or to-be-pasted content in a play order to a new currently played picture, audio, video, page, or to-be-pasted content; or
switching, when the direction of the first slide touch input is the second direction, in a document in which a currently played picture, audio, video, page, or to-be-pasted content is located, a picture, audio, video, page, or to-be-pasted content located after the currently played picture, audio, video, page, or to-be-pasted content in a play order to a new currently played picture, audio, video, page, or to-be-pasted content;
wherein a minimum angle between the second direction and the first direction is greater than or equal to 45 degrees.

13. The method according to claim 12, wherein the first direction is one of a forward direction along a side or a backward direction along the side; and
wherein the second direction is also one of the forward direction along the side or the backward direction along the side, and wherein the first direction is different from the second direction.

14. The method according to claim 12, wherein the method further comprises determining a force of the first slide touch input after the obtaining the first slide touch input, and before the switching, when the direction of the first slide touch input is the first direction, in the document in which the currently played picture, audio, video, page, or to-be-pasted content is located, the picture, audio, video, page, or to-be-pasted content located before the currently played picture, audio, video, page, or to-be-pasted content in a play order to the new currently played picture, audio, video, page, or to-be-pasted content.

15. The method according to claim 14, wherein the performing one of switching, when the direction of the first slide touch input is the first direction, in the document in which the currently played picture, audio, video, page, or to-be-pasted content is located, the picture, audio, video, page, or to-be-pasted content located before the currently played picture, audio, video, page, or to-be-pasted content in the play order to a new currently played picture, audio, video, page, or to-be-pasted content, or the switching, when the direction of the first slide touch input is the second direction, in a document in which a currently played picture, audio, video, page, or to-be-pasted content is located, a picture, audio, video, page, or to-be-pasted content located after the currently played picture, audio, video, page, or to-be-pasted content in a play order to a new currently played picture, audio, video, page, or to-be-pasted content comprises performing one of:
switching, when the first slide touch input is in the first direction, according to the force of the first slide touch input, in the document in which the currently played picture, audio, video, page, or to-be-pasted content is located, the Nth picture, audio, video, page, or to-be-pasted content located before the currently played picture, audio, video, page, or to-be-pasted content in the play order to the new currently played picture, audio, video, page, or to-be-pasted content, wherein N is a positive integer and is counted from the currently played picture, audio, video, page, or to-be-pasted content; or
switching, when the first slide touch input is in the second direction, according to the force of the first slide touch input, in the document in which the currently played picture, audio, video, page, or to-be-pasted content is located, the Nth picture, audio, video, page, or to-be-pasted content located after the currently played picture, audio, video, page, or to-be-pasted content in the play order to the new currently played picture, audio, video, page, or to-be-pasted content, wherein N is a positive integer and is counted from the currently played picture, audio, video, page, or to-be-pasted content.

16. The method according to claim 12, wherein the method further comprises:
determining a speed of the first slide touch input after the obtaining the first slide touch input, and before the switching, when the direction of the first slide touch input is the first direction, in the document in which a currently played picture, audio, video, page, or to-be-pasted content is located, the picture, audio, video, page, or to-be-pasted content located before the currently played picture, audio, video, page, or to-be-pasted content in the play order to the new currently played picture, audio, video, page, or to-be-pasted content.

17. The method according to claim 16, wherein the performing the switching, when the direction of the first slide touch input is the first direction, in the document in which the currently played picture, audio, video, page, or to-be-pasted content is located, the picture, audio, video, page, or to-be-pasted content located before the currently played picture, audio, video, page, or to-be-pasted content in the play order to a new currently played picture, audio, video, page, or to-be-pasted content, or the switching, when the direction of the first slide touch input is the second direction, in the document in which the currently played picture, audio, video, page, or to-be-pasted content is located, the picture, audio, video, page, or to-be-pasted content located after the currently played picture, audio, video, page, or to-be-pasted content in the play order to a new currently played picture, audio, video, page, or to-be-pasted content comprises performing one of:
switching, when the direction of the first slide touch input is the first direction, in the document in which the currently played picture, audio, video, page, or to-be-pasted content is located and at a switching speed corresponding to the speed of the first slide touch input, the picture, audio, video, page, or to-be-pasted content located before the currently played picture, audio, video, page, or to-be-pasted content in the play order to the new currently played picture, audio, video, page, or to-be-pasted content; or
switching, when the direction of the first slide touch input is the second direction, in the document in which the currently played picture, audio, video, page, or to-be-pasted content is located and at the switching speed corresponding to the speed of the first slide touch input, the picture, audio, video, page, or to-be-pasted content located after the currently played picture, audio, video, page, or to-be-pasted content in the play order to the new currently played picture, audio, video, page, or to-be-pasted content.

18. The method according to claim 17, further comprising
obtaining a second slide touch input applied to the side touchscreen of the handheld electronic device;
determining that a direction of the second slide touch input is the first direction or the second direction; and
performing one of:
switching, when the direction of the second slide touch input is the first direction, in the document in which the currently played picture, audio, video, page, or to-be-pasted content is located and at a switching speed corresponding to the speed of the second slide touch input, the picture, audio, video, page, or to-be-pasted content located before the currently played picture, audio, video, page, or to-be-pasted content in the play order to the new currently played picture, audio, video, page, or to-be-pasted content; or
switching, when the direction of the second slide touch input is the second direction, in the document in which the currently played picture, audio, video, page, or to-be-pasted content is located and at the switching speed corresponding to the speed of the second slide touch input, the picture, audio, video, page, or to-be-pasted content located after the currently played picture, audio, video, page, or to-be-pasted content in the play order to the new currently played picture, audio, video, page, or to-be-pasted content;
wherein the speed of the second slide touch input is greater than the speed of the first slide touch input, and wherein the switching speed corresponding to the speed of the second slide touch input is greater than the switching speed corresponding to the speed of the first slide touch input.

19. The method according to claim 18, wherein the switching, when the direction of the second slide touch input is the first direction, in the document in which the currently played picture, audio, video, page, or to-be-pasted content is located and at the switching speed corresponding to the speed of the second slide touch input, the picture, audio, video, page, or to-be-pasted content located before the currently played picture, audio, video, page, or to-be-pasted content in the play order to the new currently played picture, audio, video, page, or to-be-pasted content comprises:
multiplying the speed of the first slide touch input by a first value to obtain the switching speed corresponding to the speed of the first slide touch input, wherein the first value is a constant greater than or equal to 1; and
switching, when the direction of the second slide touch input is the first direction, in the document in which the currently played picture, audio, video, page, or to-be-pasted content is located, at the switching speed corresponding to the speed of the second slide touch input, the picture, audio, video, page, or to-be-pasted content located before the currently played picture, audio, video, page, or to-be-pasted content in the play order to the new currently played picture, audio, video, page, or to-be-pasted content.

20. The method according to claim 18, wherein the method further comprises:
determining a force of the first slide touch input after the obtaining the first slide touch input applied to a side touchscreen of the handheld electronic device, and before the switching, when the direction of the first slide touch input is the first direction, in the document in which the currently played picture, audio, video, page, or to-be-pasted content is located and at the switching speed corresponding to the speed of the first slide touch input, the picture, audio, video, page, or to-be-pasted content located before the currently played picture, audio, video, page, or to-be-pasted content in the play order to the new currently played picture, audio, video, page, or to-be-pasted content.

21. The method according to claim 20, wherein the performing one of the switching, when the direction of the first slide touch input is the first direction, in the document in which a currently played picture, audio, video, page, or to-be-pasted content is located, the picture, audio, video, page, or to-be-pasted content located before the currently played picture, audio, video, page, or to-be-pasted content in the play order to a new currently played picture, audio, video, page, or to-be-pasted content, or the switching, when the direction of the first slide touch input is the second direction, in the document in which a currently played picture, audio, video, page, or to-be-pasted content is located, the picture, audio, video, page, or to-be-pasted content located after the currently played picture, audio, video, page, or to-be-pasted content in the play order to the new currently played picture, audio, video, page, or to-be-pasted content comprises performing one of:
switching, when the first slide touch input is in the first direction, according to the force of the first slide touch input, in the document in which the currently played picture, audio, video, page, or to-be-pasted content is located, at the switching speed corresponding to the speed of the first slide touch input, the Nth picture, audio, video, page, or to-be-pasted content located before the currently played picture, audio, video, page, or to-be-pasted content in the play order to the new currently played picture, audio, video, page, or to-be-pasted content, wherein N is a positive integer and is counted from the currently played picture, audio, video, page, or to-be-pasted content; or
switching, when the first slide touch input is in the second direction, according to the force of the first slide touch input, in the document in which the currently played picture, audio, video, page, or to-be-pasted content is located, at the switching speed corresponding to the speed of the first slide touch input, the Nth picture, audio, video, page, or to-be-pasted content located after the currently played picture, audio, video, page, or to-be-pasted content in the play order to the new currently played picture, audio, video, page, or to-be-pasted content, wherein N is a positive integer and is counted from the currently played picture, audio, video, page, or to-be-pasted content.

22. A handheld electronic device, comprising:
a side sensor, configured to obtain a first slide touch input applied to a side touchscreen of the handheld electronic device;
a processor;
a non-transitory computer-readable storage medium storing a program to be executed by the processor, the program including instructions to:
determine a direction of the first slide touch input; and
zoom out or in, according to the direction of the first slide touch input, a picture displayed on a display screen of the handheld electronic device;
a display screen, configured to display the picture in the handheld electronic device; and
a memory, configured to store the picture in the handheld electronic device.

23. The handheld electronic device according to claim 22, wherein the instructions to determine the direction of the first slide touch input, include instructions to determine that the direction of the slide touch input is a first direction or a second direction; and
wherein the instructions to zoom out or in the picture include instructions to perform one of:
zoom in the picture displayed on the display screen when the direction of the first slide touch input is the first direction, or
zoom out the picture displayed on the display screen when the direction of the first slide touch input is the second direction;
wherein a minimum angle between the second direction and the first direction is greater than or equal to 45 degrees.

24. The handheld electronic device according to claim 22, wherein the first direction is one of a forward direction along a side or a backward direction along the side; and
wherein the second direction is one of the forward direction along the side or the backward direction along the side, and wherein the first direction is different from the second direction.

25. The handheld electronic device according to claim 24, wherein the program further includes instructions to determine a force of the first slide touch input.

26. The handheld electronic device according to claim 25, wherein the instructions to zoom out or in the picture include instructions to zoom out or in, according to the direction and the force of the first slide touch input and in a specific ratio corresponding to the force of the first slide touch input, the picture displayed on the display screen of the handheld electronic device.

27. The handheld electronic device according to claim 22, wherein the program further includes instructions to determine a speed of the first slide touch input.

28. The handheld electronic device according to claim 27, wherein the instructions to zoom out or in the picture include instructions to zoom out or in the picture according to the direction and the speed of the first slide touch input and at a zooming speed corresponding to the speed of the first slide touch input.

29. The handheld electronic device according to claim 28, wherein the program further includes instructions to:
obtain a second slide touch input applied to the side touchscreen of the handheld electronic device;
determine a direction and a speed of the second slide touch input; and
zoom out or in the picture according to the direction and the speed of the second slide touch input and at a zooming speed corresponding to the speed of the second slide touch input;
wherein the speed of the second slide touch input is greater than the speed of the first slide touch input, and the zooming speed corresponding to the speed of the second slide touch input is greater than the zooming speed corresponding to the speed of the first slide touch input.

30. The handheld electronic device according to claim 29, wherein the instructions to zoom out or in the picture according to the direction and the speed of the first slide touch input and at a zooming speed corresponding to the speed of the first slide touch input include instructions to multiply the speed of the first slide touch input by a first value to obtain the zooming speed corresponding to the speed of the first slide touch input, and zoom out or in the picture according to the direction and the speed of the first slide touch input and at the zooming speed corresponding to the speed of the first slide touch input, wherein the first value is a constant greater than or equal to 1.

31. The handheld electronic device according to claim 30, wherein the program further includes instructions to determine a force of the first slide touch input.

32. The handheld electronic device according to claim 31, wherein the instructions to zoom out or in the picture include instructions to zoom out or in, according to the direction, the speed, and the force of the first slide touch input, the picture at the zooming speed corresponding to the speed of the first slide touch input and with a zooming force corresponding to the force of the first slide touch input.

33. A handheld electronic device, comprising:
a side sensor, configured to obtain a first slide touch input applied to a side touchscreen of the handheld electronic device;
a processor;
a non-transitory computer-readable storage medium storing a program to be executed by the processor, the program including instructions to:
determine that a direction of the first slide touch input is a first direction or a second direction; and
perform one of:
switch, when the direction of the first slide touch input is the first direction, in a document in which a currently played picture, audio, video, page, or to-be-pasted content is located, a picture, audio, video, page, or to-be-pasted content located before the currently played picture, audio, video, page, or to-be-pasted content in a play order to a new currently played picture, audio, video, page, or to-be-pasted content; or
switch, when the direction of the first slide touch input is the second direction, in a document in which a currently played picture, audio, video, page, or to-be-pasted content is located, a picture, audio, video, page, or to-be-pasted content located after the currently played picture, audio, video, page, or to-be-pasted content in a play order to a new currently played picture, audio, video, page, or to-be-pasted content;
a display screen, configured to display a picture, audio, a video, a page, or to-be-pasted content in the handheld electronic device; and
a memory, configured to store the picture, audio, video, page, or to-be-pasted content in the handheld electronic device;
wherein a minimum angle between the second direction and the first direction is greater than or equal to 45 degrees.

34. The handheld electronic device according to claim 33, wherein the first direction is one of a forward direction along a side or a backward direction along the side; and
the second direction is one of the forward direction along the side or the backward direction along the side, and wherein the first direction is different from the second direction.

35. The handheld electronic device according to claim 33, wherein the program further includes instructions to determine a force of the first slide touch input.

36. The handheld electronic device according to claim 35, wherein the program further includes instructions to:
switch, when the first slide touch input is in a specific direction , according to the force of the first slide touch input, in the document in which the currently played picture, audio, video, page, or to-be-pasted content is located, the Nth picture, audio, video, page, or to-be-pasted content located before the currently played picture, audio, video, page, or to-be-pasted content in the play order to the new currently played picture, audio, video, page, or to-be-pasted content, wherein N is a positive integer; and
switch, when the first slide touch input is in a direction opposite to a specific direction, according to the force of the first slide touch input, in the document in which the currently played picture, audio, video, page, or to-be-pasted content is located, the Nth picture, audio, video, page, or to-be-pasted content located after the currently played picture, audio, video, page, or to-be-pasted content in the play order to the new currently played picture, audio, video, page, or to-be-pasted content, wherein N is a positive integer.

37. The handheld electronic device according to claim 33, wherein the program further includes instructions to determine a speed of the first slide touch input.

38. The handheld electronic device according to claim 37, wherein the program further includes instructions to perform one of:
switch, when the direction of the first slide touch input is the first direction, in the document in which the currently played picture, audio, video, page, or to-be-pasted content is located, at a switching speed corresponding to the speed of the first slide touch input, the picture, audio, video, page, or to-be-pasted content located before the currently played picture, audio, video, page, or to-be-pasted content in the play order to the new currently played picture, audio, video, page, or to-be-pasted content; or
switch, when the direction of the first slide touch input is the second direction, in the document in which the currently played picture, audio, video, page, or to-be-pasted content is located, at the switching speed corresponding to the speed of the first slide touch input, the picture, audio, video, page, or to-be-pasted content located after the currently played picture, audio, video, page, or to-be-pasted content in the play order to the new currently played picture, audio, video, page, or to-be-pasted content.

39. The handheld electronic device according to claim 38, the program further includes instructions to obtain a second slide touch input applied to the side touchscreen of the handheld electronic device;
determine that a direction of the second slide touch input is the first direction or the second direction; and
perform one of
switch, when the direction of the second slide touch input is the first direction, in the document in which the currently played picture, audio, video, page, or to-be-pasted content is located, at a switching speed corresponding to the speed of the second slide touch input, the picture, audio, video, page, or to-be-pasted content located before the currently played picture, audio, video, page, or to-be-pasted content in the play order to the new currently played picture, audio, video, page, or to-be-pasted content; or
switch, when the direction of the second slide touch input is the second direction, in the document in which the currently played picture, audio, video, page, or to-be-pasted content is located, at a switching speed corresponding to the speed of the second slide touch input, the picture, audio, video, page, or to-be-pasted content located after the currently played picture, audio, video, page, or to-be-pasted content in the play order to the new currently played picture, audio, video, page, or to-be-pasted content;
wherein the speed of the second slide touch input is greater than the speed of the first slide touch input, and the switching speed corresponding to the speed of the second slide touch input is greater than the switching speed corresponding to the speed of the first slide touch input.

40. The handheld electronic device according to claim 39, wherein the program further includes instructions to multiply the speed of the first slide touch input by a first value to obtain the switching speed corresponding to the speed of the first slide touch input, wherein the first value is a constant greater than or equal to 1.

41. The handheld electronic device according to claim 37, wherein the program further includes instructions to determine a force of the first slide touch input.

42. The handheld electronic device according to claim 41, wherein the program further includes instructions to perform one of:
switch, when the first slide touch input is in the first direction, according to the force of the first slide touch input, in the document in which the currently played picture, audio, video, page, or to-be-pasted content is located, at the switching speed corresponding to the speed of the first slide touch input, the Nth picture, audio, video, page, or to-be-pasted content located before the currently played picture, audio, video, page, or to-be-pasted content in the play order to the new currently played picture, audio, video, page, or to-be-pasted content, wherein N is a positive integer and is counted from the currently played picture, audio, video, page, or to-be-pasted content; or
switch, when the first slide touch input is in the second direction, according to the force of the first slide touch input, in the document in which the currently played picture, audio, video, page, or to-be-pasted content is located, at the switching speed corresponding to the speed of the first slide touch input, the Nth picture, audio, video, page, or to-be-pasted content located after the currently played picture, audio, video, page, or to-be-pasted content in the play order to the new currently played picture, audio, video, page, or to-be-pasted content, wherein N is a positive integer and is counted from the currently played picture, audio, video, page, or to-be-pasted content.
